(19) United States
(12) Patent Application Publication
(10) Pub. No.: US 2025/0271045 A1
(43) Pub. Date: Aug. 28, 2025

(54) Damping assembly with radial projection, support, and method of manufacturing support

(71) Applicant: Sumitomo Riko Company Limited, Aichi (JP)

(72) Inventors: Pascal CAROBOLANTE, Sauvigny les bois (FR); Florian KASZYCA, Lucenay les Aix (FR); Serge VERGER, La Machine (FR); Damien AUGARDE, Yzeure (FR)

(73) Assignee: Sumitomo Riko Company Limited, Aichi (JP)

(21) Appl. No.: 19/051,137

(22) Filed: Feb. 11, 2025

(30) Foreign Application Priority Data
Feb. 22, 2024 (FR) 2401759

(51) Int. Cl. F16F 1/38

(52) U.S. Cl. CPC F16F 1/3842; F16F 2224/025; F16F 2226/04; F16F 2230/36; F16F 2234/02

(57) ABSTRACT

A damping assembly includes a mount comprising a circular opening and a support configured to be inserted into said circular opening of said mount. The support comprises a baseplate having a cylindrical outer lateral surface. The support comprises a damping cylinder comprising an inner lateral surface surrounding the outer lateral surface of said base and an outer lateral surface configured to be held on said circular opening. Said damping cylinder comprises at least one radial projection protruding from the inner lateral surface of said damping cylinder or from the outer lateral surface of said damping cylinder.

### CROSS-REFERENCE TO RELATED APPLICATION

This application claims the priority benefit of France application serial no. 2401759, filed on Feb. 22, 2024. The entirety of the above-mentioned patent application is hereby incorporated by reference herein and made a part of this specification.

### BACKGROUND

### Technical Field

The present disclosure relates to the field of damping assemblies, for example damping assemblies for vehicles (for example, cars or trucks).

### Background Art

Damping assemblies may be used to absorb and/or damp vibrations and/or shocks between mechanical parts forming part of the same assembly. In particular, such damping assemblies may be used in the automotive sector to connect different mechanical parts of a vehicle.

In particular, such damping assemblies may each be constituted of a mount comprising a circular opening and a support configured to be inserted into the circular opening of the mount. The support is generally configured to serve as support for a mechanical part, this being mechanically connected to the mount by means of the support. The support generally comprises a damping part allowing to absorb and/or damp vibrations and/or shocks between the mount and the mechanical part bearing on the support.

FIG. 1 shows an example of such a damping assembly support 100. The support 100 comprises a base 110 presenting a rod 112 having a cylindrical outer lateral surface and a shoulder 114 arranged at one end of said rod 112. The support 100 also comprises a damping cylinder 120 comprising an inner lateral surface surrounding the outer lateral surface of said rod 112 and an outer lateral surface 122 configured to be held on the circular opening of the mount. FIG. 2 shows the insertion of the support 100 of FIG. 1 on the mount 130, and, in particular, the holding of the outer lateral surface 122 of the damping cylinder 120 on the circular opening 131 of the mount 130 by insertion of the edge of the circular opening 131 in a circumferential groove formed on the periphery of the damping cylinder 120.

The damping cylinder serves to absorb and/or damp vibrations and/or shocks between the mechanical part bearing on the support and the mount. The damping provided by such an assembly may be measured, in particular, by a radial curve representing an applied force as a function of the radial displacement of the support (or of the mechanical part bearing thereon) relative to the mount, in other words, perpendicular to the axis of the damping cylinder.

FIG. 3 shows an example of such a radial curve measured for the examples of the damping assembly illustrated in FIG. 1 and FIG. 2. In particular, FIG. 3 shows the radial curve 141 measured for a first example of the damping assembly in which the clamping between the support and the mount is minimal, and the radial curve 142 measured for a second example of the damping assembly in which the clamping between the support and the mount is maximal. In each of these examples, the clamping between the support and the mount results from dimensional variations induced by the manufacturing tolerances of the assembly parts. These variations result in a greater or lesser degree of clamping between the support and the mount.

A limitation of current damping assemblies is that damping may degrade as a function of this clamping when the support is centered on the circular opening. This degradation is caused, in particular, by the presence of a clearance between the support and the mount resulting from the manufacturing tolerances of the assembly parts and leading to a drop in stiffness at the origin. This is reflected on the radial curve by an accelerated decrease in stiffness around the origin. The example in FIG. 3 notably shows the drop in stiffness at the origin for the radial curve measured for the second example. This drop in stiffness degrades the vibration and/or shock absorption qualities of the damping assembly.

There is therefore a need for an improved damping unit.

### SUMMARY

To this end, a damping assembly is proposed comprising a mount comprising a circular opening and a support configured to be inserted into said circular opening of said mount. The support comprises a base having a cylindrical outer lateral surface. The support comprises a damping cylinder comprising an inner lateral surface surrounding the outer lateral surface of said base and an outer lateral surface configured to be held on said circular opening. Said damping cylinder comprises at least one radial projection protruding from the inner lateral surface of said damping cylinder or from the outer lateral surface of said damping cylinder.

The assembly may comprise a circular gap between said base and said circular opening when the support is inserted into said circular opening. Said at least one radial projection may have a radial thickness greater than that of said circular gap.

The thickness of said, at least one, radial protrusion may be greater than the sum of the manufacturing tolerance of the mount or base and the manufacturing tolerance of the damping cylinder.

Said damping cylinder may comprise a single radial projection. Said single radial projection may be positioned longitudinally substantially in the center of said base.

Said damping cylinder may comprise a plurality of radial projections. Said radial projections may be longitudinally distributed along said base.

Both ends of said damping cylinder may comprise a respective shoulder forming a circumferential groove around said cylinder. Said circular opening may comprise a circular edge. Said damping cylinder may be held on said circular opening by inserting said circular edge of said circular opening into said circumferential groove.

Said damping cylinder may be of elastomeric material.

Said, at least one, radial projection may extend over all or part of the circumference of said damping cylinder.

A support belonging to such an assembly is also proposed, in which said, at least one, radial projection protrudes from the outer lateral surface of said cylinder.

A support belonging to such an assembly is also proposed, in which said, at least one, radial projection protrudes from the inner lateral surface of said cylinder.

A method of manufacturing a support belonging to such an assembly is also proposed, in which said, at least one, radial projection projects from the outer lateral surface of said cylinder.

A method for manufacturing a support belonging to such an assembly is also proposed, in which said, at least one, radial projection protrudes from the inner lateral surface of said cylinder.

### BRIEF DESCRIPTION OF THE FIGURES

Non-limiting examples will be described with reference to the following figures:

FIG. 1 and FIG. 2 illustrate an example of an existing damping assembly.

FIG. 3 shows an example of a measured radial curve for examples of the existing damping assembly illustrated in FIG. 1 and FIG. 2.

FIG. 4, FIG. 5, FIG. 6 and FIG. 7 illustrate an example of a support.

FIG. 8 illustrates the radial projection of the support example of FIGS. 4 to 7.

FIG. 9 shows the measured radial curve for an assembly comprising the support example of FIGS. 4 to 7.

FIG. 10 and FIG. 11 illustrate an example of a damping assembly.

FIG. 12 shows examples of radial curves measured for damping assemblies such as the one shown in FIG. 10.

FIG. 13 shows another example of a damping assembly.

FIG. 14 shows the radial projection of the support example of FIG. 13.

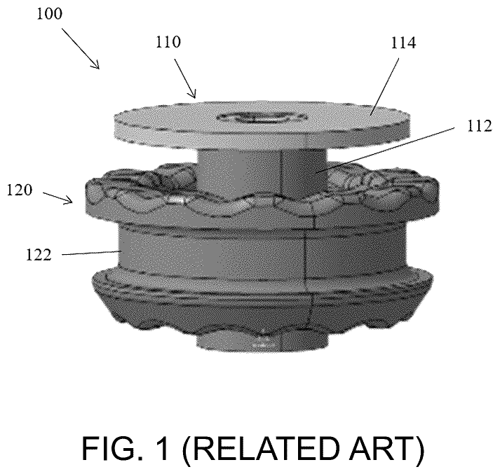

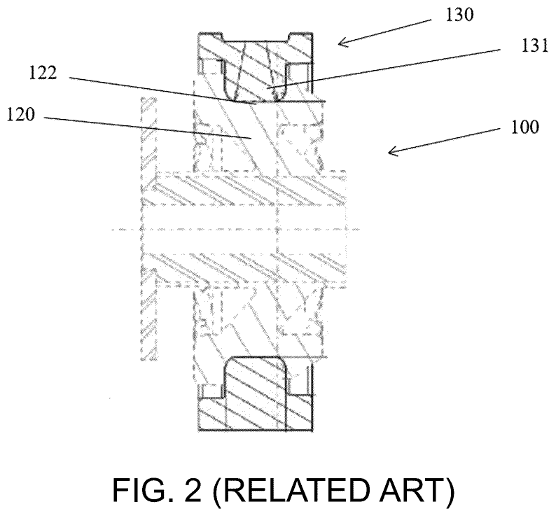

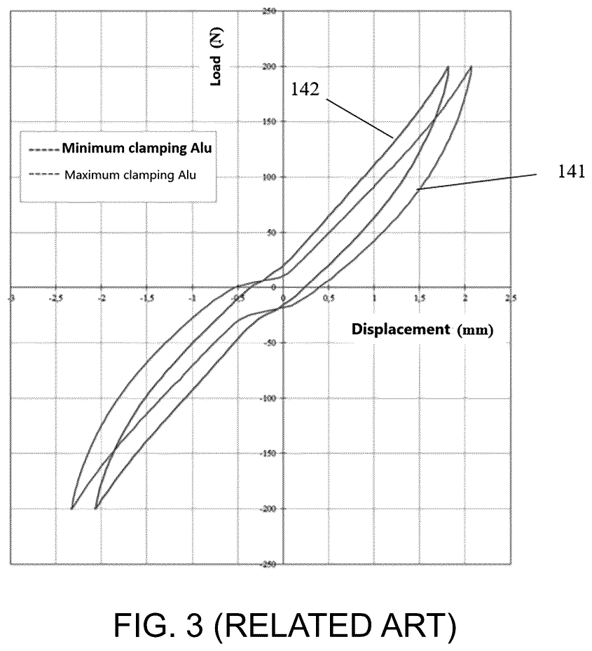

### DETAILED DESCRIPTION

A damping assembly is proposed comprising a mount comprising a circular opening and a support configured to be inserted within said circular opening of said mount. The support comprises a base having a cylindrical outer lateral surface. The support comprises a damping cylinder comprising an inner lateral surface surrounding the outer lateral surface of said base and an outer lateral surface configured to be held on said circular opening. Said damping cylinder comprises at least one radial projection protruding from the inner lateral surface of said damping cylinder or from the outer lateral surface of said damping cylinder.

This constitutes an improved damping assembly.

Indeed, the at least one radial projection takes up the clearance between the support and the mount, thus preventing damping degradation around the origin. In particular the at least one radial projection allows this degradation to be prevented without significantly modifying the operation of the damping assembly. The damping assembly therefore obtains an equivalent damping but without degradation around the origin.

In particular, the radially protruding shape is particularly suitable for overcoming variations in shape induced by the manufacturing tolerances of the support and the mount. Indeed, it allows a more or less strong crushing in the clearance between the support and the mount to compensate for these dimensional variations. The proposed damping assembly therefore provides adequate damping irrespective of these dimensional variations.

In addition, the damping assembly is particularly easy to manufacture. Indeed, by compensating for manufacturing tolerances, the presence of the at least one radial projection allows the damping assembly to be manufactured without the need to excessively reduce and/or control these manufacturing tolerances, thus simplifying the manufacturing process. Furthermore, the manufacture of a damping cylinder comprising such an at least one radial projection is not difficult to achieve, which contributes to improving the ease of manufacture of the damping assembly.

The damping assembly may be used in a vehicle. In this case, the mount (also called “housing”) may be a structural part of the vehicle, in other words, a part forming part of the vehicle structure, and which may have a significant dimension in the vehicle. For example, the mount may be part of the vehicle chassis or engine. The support may serve to bear a part which comes, by means of this support, to be held on the mount, in other words, a part that is smaller and/or lighter than the mount. For example, the support may serve to bear a radiator, or any other part needing to be held on a mount at a circular opening. The damping assembly is configured to ensure the hold between the mount and this part which comes to be held on the mount. In particular, the damping assembly is configured to damp the vibrations and shocks between the mount and the part bearing on the support and which comes to be held on the mount.

The damping assembly may be constituted according to a main axis. For example, the base (also known as the “inner frame”) may be in the form of a rod comprising a central cylindrical hole. The damping cylinder and the base may be according to the same axis (said main axis). The circular opening of the mount may be, when the support is inserted in the circular opening, oriented perpendicularly to this axis of the rod formed by the base and the damping cylinder, and is centered on this axis.

The circular opening of the mount may be perfectly circular, in other words, it may comprise an edge the cross-section of which, in a plane perpendicular to the axis of the damping assembly, is a circle. Alternatively, the opening of the mount may be substantially circular, for example oval. In this case, the circular opening of the mount may comprise an edge the cross-section of which, in a plane perpendicular to the axis of the damping assembly, is oval or elliptical.

The base may be inserted into the circular opening when the support comes to be inserted into the circular opening, in other words, the two ends of the base may be located on either side of the circular opening when the support is inserted into the circular opening.

The base serves for bearing a mechanical part (such as a radiator) without it coming into contact with the mount. Such a mechanical part may comprise a rod configured to be inserted into the central cylindrical hole of the base. The bearing of the mechanical part may result from its contact with the base when the rod of the mechanical part comes to be inserted into the central cylindrical hole, said contact blocking the displacement of the mechanical part in directions perpendicular to the axis of the support and/or in the direction of the axis of the support.

When the support is inserted in the circular opening of the mount, the damping cylinder is located between the base and the circular opening. In particular, the damping cylinder comprises an inner lateral surface surrounding the outer lateral surface of the base and an outer lateral surface configured to be held on said circular opening. The damping cylinder is thus configured to damp the vibrations and/or shocks between the mount and the base serving as a bearing for the part.

The damping cylinder may be of an elastomeric material, in other words, it may be constituted entirely or partly of an elastomer. For example, the damping cylinder may be of elastomer (silicone or rubber or TPE).

The mount may be of metal or plastic material. For example, the mount may be made of aluminum. Similarly, the base may be made of a metal (for example, aluminum) or plastic material.

In the examples, the assembly may comprise a circular gap between the base and the circular opening when the support is inserted into the circular opening. The circular gap may be a clearance between the mount, the damping cylinder and the base when the support is inserted in the circular opening, which may be induced by the manufacturing tolerances of the different parts of the damping assembly (base, damping cylinder and/or mount).

According to a first option, this circular gap may be located between the damping cylinder and the circular opening, in other words, between the outer lateral surface of the damping cylinder and the edge of the circular opening. For example, the outer lateral surface of the cylinder may have a diameter less than the diameter of the edge of the circular opening. In this first option, the, at least one, radial projection may protrude from the outer lateral surface of said damping cylinder, toward the outside of the damping cylinder. The at least one radial projection may thus fill that circular gap in the assembly, which is located between the damping cylinder and the circular opening of the mount.

In this first option, there may be no clearance between the base and the damping cylinder. The inner lateral surface of the damping cylinder may be in contact with the outer cylindrical lateral surface of the base. For example, the damping cylinder may have been molded onto the support base (on its cylindrical outer lateral surface), with or without adhesion. Bonding may guarantee contact between the damping cylinder and the base.

According to a second option, the circular gap may be located between the base and the damping cylinder, in other words, between the inner lateral surface of the damping cylinder and an outer lateral surface of the base. For example, the inner lateral surface of the damping cylinder may have a diameter larger than the diameter of the cylindrical outer lateral surface of the base. In this second option, the at least one radial projection may protrude from the inner lateral surface of said damping cylinder, toward the interior of the damping cylinder. The at least one radial projection may thus fill this circular gap in the assembly, which is located between the base and the damping cylinder.

In this second option, there may be no clearance between the damping cylinder and the circular opening in the mount. The outer lateral surface of the damping cylinder may be in contact with the edge of the circular opening. The damping cylinder may be molded, with or without reinforcement. For example, the damping cylinder may have an external diameter slightly greater than that of the circular aperture, so that it is compressed into the circular opening when the support is inserted into the mount. The damping cylinder may thus be force-fitted onto the circular opening. Alternatively, the damping cylinder may have been molded directly onto the circular opening of the mount, with or without adhesion. Adhesion may guarantee contact between the damping cylinder and the circular opening of the mount.

In a third option, which is a combination of the first two, the assembly may comprise a first circular gap between the damping cylinder and the circular opening and a second circular gap between the base and the damping cylinder. In this case, the damping cylinder may comprise at least one first radial projection protruding from the inner lateral surface of the damping cylinder (as in the first option) and at least one second radial projection protruding from the outer lateral surface of said damping cylinder (as in the second option).

In the examples, in the first and second options, the damping cylinder may comprise a single radial projection. This radial projection may be positioned longitudinally substantially in the center of the base. In the third option, the damping cylinder may similarly comprise a single radial projection at each of the two circular gaps.

In other examples, in the first and second options, the damping cylinder may comprise a plurality of radial projections. These radial projections may be distributed longitudinally along the base. For example, the damping cylinder may comprise a first radial projection at the center, and two additional radial projections located longitudinally above and below this first radial projection respectively. In the third option, the damping cylinder may similarly comprise a plurality of radial projections at each of the two circular gaps.

A radial projection is now discussed in more detail. These details apply to the radial projection of the damping cylinder when it comprises only one, or to each of the radial projections when the damping cylinder comprises several.

The radial projection protrudes from the inner lateral surface of the damping cylinder or from the outer lateral surface of the damping cylinder. The radial projection may have the general shape of a hump. The radial projection may have a section of any shape. For example, in a cross-section according to a longitudinal plane, the radial projection may have a section of generally semicircular, square or triangular shape. The radial projection may also comprise rounded edges at the junctions with the lateral surface from which the radial projection protrudes. In such a cross-section according to a longitudinal plane, the section of the radial projection may vary along the circumference of the damping cylinder (for example, in thickness or shape). Alternatively, the section of the radial projection may be constant over the entire circumference.

The radial projection encircles all or part of the circumference of the lateral surface from which the radial projection protrudes. The radial projection may extend over part of the circumference of the damping cylinder. For example, the radial projection may extend over at least 1% of the circumference, or at least 2%, for example at least 50% or 80%. Within this percentage of the circumference, the radial projection may be continuous or discontinuous. Alternatively, the radial projection may extend over the entire circumference of the damping cylinder. In this case, the radial projection may be continuous over the entire circumference of the damping cylinder.

The radial projection may have a radial thickness greater than that of the cylindrical gap which as a whole it fills. The radial thickness is that in the direction which is normal to the lateral surface from which the radial projection protrudes. Such a radial thickness allows to guarantee that the radial projection is compressed when the support is inserted into the opening, which ensures stiffness at the origin. For example, in the case of the first option, the thickness of the radial projection may be greater than the result of the sum of the manufacturing tolerance of the mount (for example, that of the circular opening of the mount) and the manufacturing tolerance of the damping cylinder (for example, that of the diameter of the outer lateral surface of the damping cylinder). For example, the radial projection may have a radial thickness equal to the result of this sum of tolerances to which a predetermined dimension (for example, equal to an average of these tolerances) is added. In the case of the second option, the thickness of the radial projection may be greater than the result of the sum of the manufacturing tolerance of the base (for example, that of the external diameter of the base) and the manufacturing tolerance of the damping cylinder (for example, that of the diameter of the inner lateral surface of the damping cylinder). For example, the radial projection may have a radial thickness equal to the result of this sum of tolerances to which a predetermined dimension (for example, equal to an average of these tolerances) is added. In both options, the radial thickness of the radial projection may also be less than twice the circular gap.

In the third option, the thickness of the at least one first radial projection protruding from the outer lateral surface of the damping cylinder may be the same as in the first option, and that of the at least one second radial projection protruding from the inner lateral surface of the damping cylinder may be the same as in the second option.

The width of the radial projection (in the direction of the support axis) may be less than the height of the damping cylinder. For example, the width of the radial projection may be less than 50% of the height of the damping cylinder and/or greater than 1% of the height of the damping cylinder (for example, the width may be between 2% and 15% of the height of the damping cylinder). The width of the radial projection may be twice its thickness.

The damping cylinder may be held on the circular opening of the mount in any way. In the examples, holding the damping cylinder on the circular opening of the mount may be ensured by force-fitting the damping cylinder onto the circular opening. For example, the two ends of said damping cylinder may comprise a respective shoulder each forming a respective circumferential lip around said cylinder, the two lips forming a circumferential groove between them. The circular opening may comprise a circular edge. The damping cylinder may be held on the circular opening by inserting the circular edge of the circular opening into the two circumferential lips formed by the shoulders of the damping cylinder.

A support is also proposed according to the first option, in other words, in which the at least one radial projection protrudes from the outer lateral surface of the damping cylinder. Such a support may comprise no matter which (one) or any combination of the features described above relating to the damping assembly.

A method is also proposed for manufacturing a support according to the first option, in other words, in which the at least one radial projection protrudes from the outer lateral surface of the damping cylinder. The manufacturing method comprises manufacturing the support with the damping cylinder comprising the at least one radial projection. For example, the method may comprise manufacturing the base and then molding the damping cylinder onto the manufactured base. In particular, molding may be carried out on the base, on its cylindrical outer lateral surface. The molding of the damping cylinder onto the base may be a molding with or without adhesion. The manufacturing method may then comprise the insertion of the manufactured support into the circular opening of the mount. The manufacturing method mayor may not include the manufacture of this mount (for example, before or after the manufacture of the support).

A support according to the second option is also proposed, in other words, in which the at least one radial projection protrudes from the inner lateral surface of the damping cylinder. Such a support may comprise no matter which or any combination of the features described above relating to the damping assembly.

A method of manufacturing a support according to the second option is also proposed, in other words, in which the at least one radial projection protrudes from the inner lateral surface of the damping cylinder. The manufacturing method comprises manufacturing the support with the damping cylinder comprising the at least one radial projection. The manufacturing method may then comprise insertion of the manufactured support into the circular opening of the mount. The manufacturing method may or may not include the manufacture of this mount (for example, before or after the manufacture of the support).

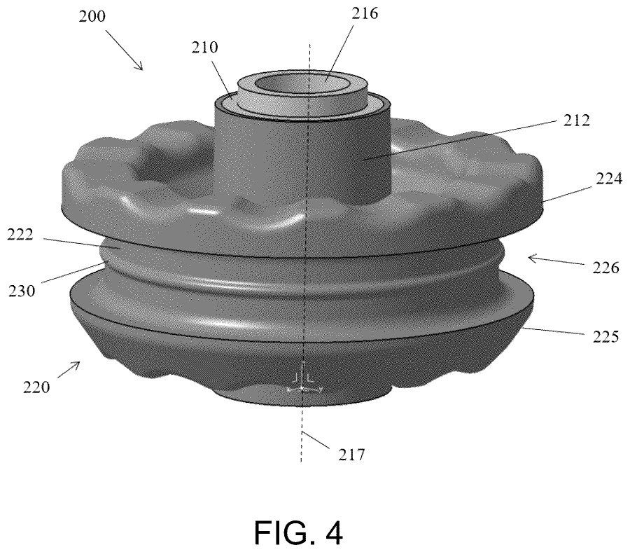

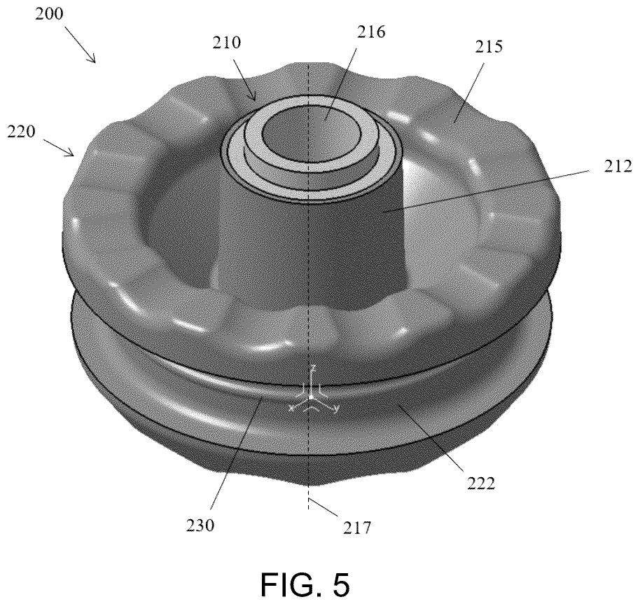

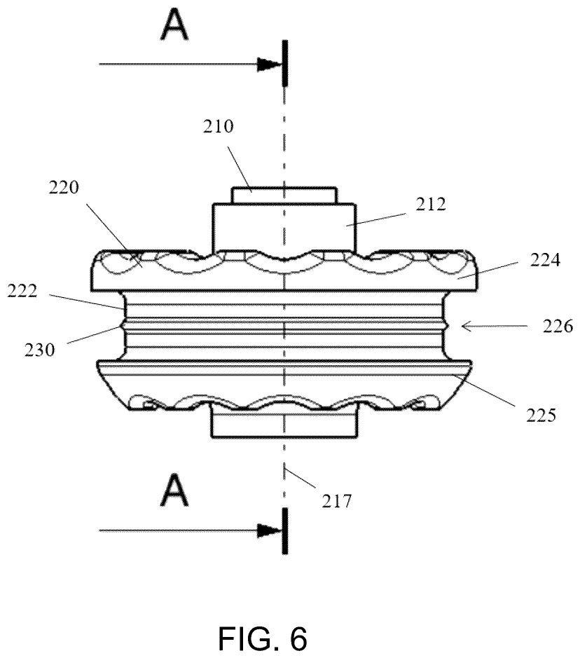

Examples of damping assemblies will now be described with reference to FIGS. 4 to 14. In these examples, the damping assemblies may be used in a vehicle, for example to support a radiator.

FIG. 4 and FIG. 5 illustrate an example of a support 200. This example is for a damping assembly according to the first of the options discussed above. The support 200 comprises a base 210 having the form of a rod with a cylindrical outer lateral surface.

The base 210 also comprises a central cylindrical hole 216 centered on the axis of the support 200. The central cylindrical hole 216 passes through the middle of the base 210. The base 210 may serve to bear a mechanical part, such as a radiator. Such a mechanical part may comprise a rod configured to be inserted into the central cylindrical hole 216 of the base 210. The bearing of the mechanical part may result from its contact with the base 210 when the rod ofthe mechanical part is inserted into the central cylindrical hole 216, said contact blocking the displacement of the mechanical part in the perpendicular directions and the direction normal to the axis of the support 217.

The support 200 also comprises the damping cylinder 220. The damping cylinder 220 comprises an inner lateral surface surrounding the outer lateral surface of the base 210 and an outer lateral surface 222. The damping cylinder 220 comprises in its middle a central cylinder 212, in which the base may be pressed. The inner lateral surface surrounding the outer lateral surface of the base 210 is formed in this central cylinder.

The outer lateral surface 222 is configured to, when the support 200 is inserted into a mount, hold the support 200 on the mount. In particular, the outer lateral surface 222 is configured to be held on the circular opening of the mount. In this example, the two ends of said damping cylinder comprise a respective shoulder 224, 225 forming a circumferential groove 226 around the cylinder. The damping cylinder 220 is held on the circular opening of the mount by inserting the circular edge of the circular opening into this circumferential groove 226 formed by the shoulders 224, 225.

The damping cylinder 220 also comprises a radial projection 230, which is unique in this example, and which protrudes from the outer lateral surface 222 of the damping cylinder 220. The radial projection 230 is, when the support 200 is inserted into the circular opening of the mount, compressed into the circular gap between the outer lateral surface 222 of the damping cylinder and the circular edge (or inner wall) of the mount. The radial projection 230 encircles the circumference of the outer lateral surface 222. The radial projection 230 is positioned longitudinally, in other words, along the support axis 217, substantially at the center of the base 210 and the damping cylinder. The radial projection 230 is positioned longitudinally at the center of the circumferential groove 226 formed by the shoulders 224, 225.

FIG. 6 shows a schematic view of the support 200 illustrated in FIG. 4, FIG. 5, and FIG. 7 a view according to section AA of this support 200.

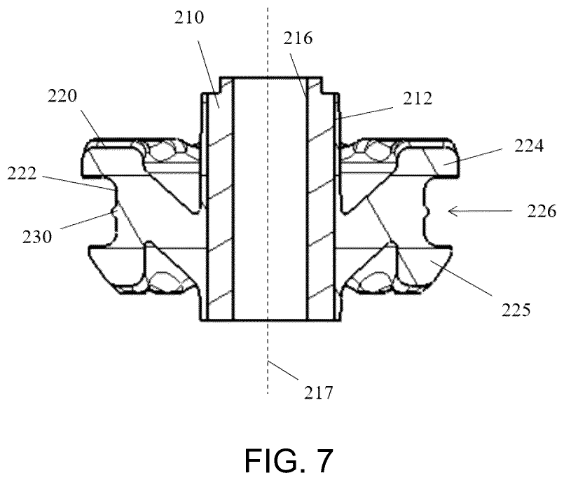

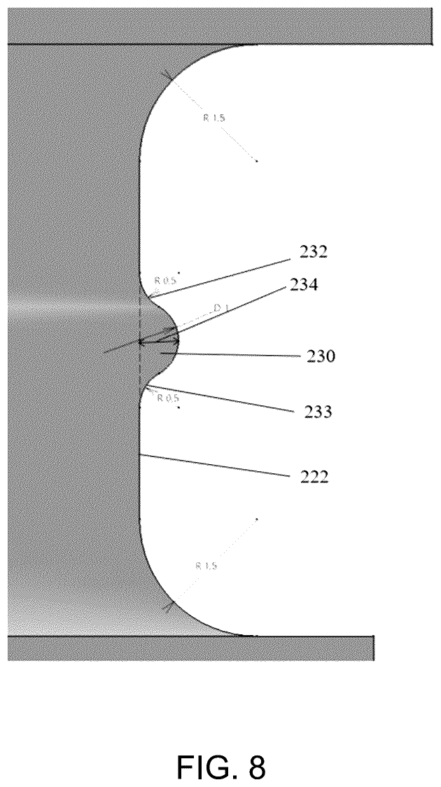

The radial projection 230 is now discussed in more detail with reference to FIG. 8. In this example, the radial projection 230 has a generally semicircular cross-sectional shape. The radial projection 230 also comprises rounded edges 232, 233 at the junctions with the outer lateral surface 222 of the damping cylinder. The cross-section of the radial projection 230 is constant around the entire circumference of the outer lateral surface 222. The radial projection 230 has a thickness 234 greater than the sum of the manufacturing tolerance of the mount 210 (0.2 millimeters in this example) and the manufacturing tolerance of the damping cylinder 220 (0.2 millimeters in this example). The radial projection 230 has, for example, a thickness 234 equal to 0.5 millimeters or 0.6 millimeters.

FIG. 9 shows the radial curve measured for an assembly comprising the example of the support illustrated in FIGS. 4 to 7. It may be seen that, by bridging the gap between the support and the mount, the radial projection prevents the degradation of damping around the origin. Indeed, stiffness remains constant at the origin in both loading directions (the slope of the curve does not vary significantly near the origin). In particular, the radial projection allows this stiffness to be maintained without any significant change in the overall stiffness of the damping assembly. This means that elsewhere than around the origin, the radial curve remains similar to that which would have been obtained for an equivalent assembly without radial projection. The damping assembly therefore provides procures equivalent damping without degradation around the origin.

The shape of the radial projection allows, in particular, to adapt to variations in shape induced by the manufacturing tolerances of the support and mount. It allows a more or less strong compression in the clearance between the support and the mount to compensate for these variations. The damping assembly therefore adapts to the variations induced by the manufacturing tolerances of the assembly parts. The damping assembly provides adequate damping independently of the dimensional variations induced by these tolerances.

Furthermore, the damping assembly is particularly easy to manufacture. Indeed, by compensating for manufacturing tolerances, the radial projection avoids the need for excessive control of these manufacturing tolerances, thus simplifying the manufacturing process. The manufacture of the damping cylinder with such a radial projection is moreover not difficult to carry out, which contributes to improving the ease of manufacture of the damping assembly.

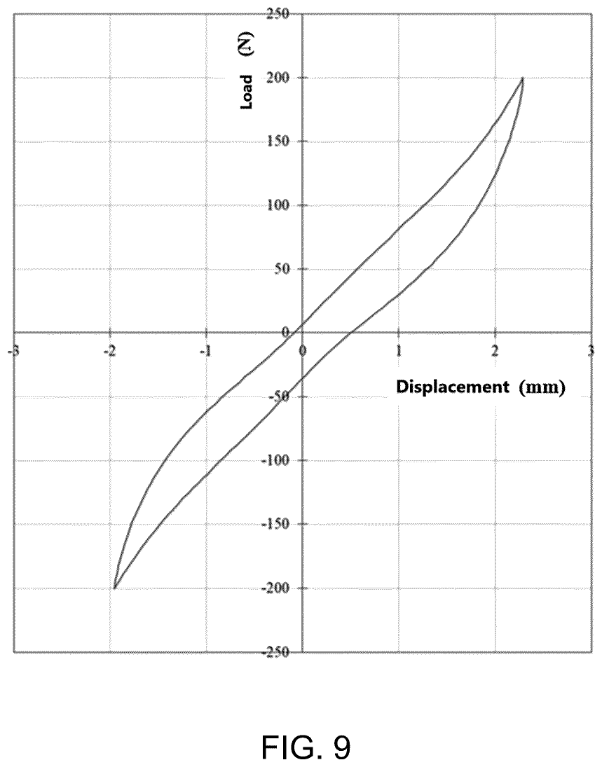

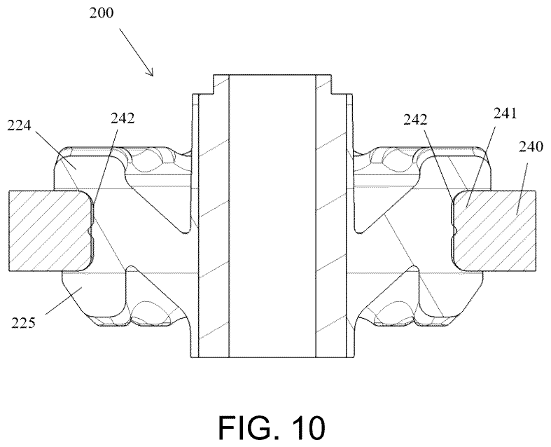

FIG. 10 illustrates an example of a damping assembly. The damping assembly comprises the support 200 illustrated in FIGS. 4 to 7 and the mount 240. The mount 240 comprises a circular opening 242. The support 200 is configured to be inserted into the circular opening 242 of the mount 240. In particular, the two ends of said damping cylinder comprise a respective shoulder 224, 225 forming a circumferential groove 226 around the cylinder. The circular opening 242 comprises a circular edge 241. The damping cylinder is held on the circular opening 242 by insertion, when the support 200 is pushed into the opening 242, of the circular edge 241 of the circular opening 242 into the circumferential groove 226 formed by the shoulders 224, 225. The mount 240 and the base of the support 200 are in aluminum in this example, and the damping cylinder 220 in silicone. The mount 240 has a cylindrical internal shape in this example but may have any shape in other examples.

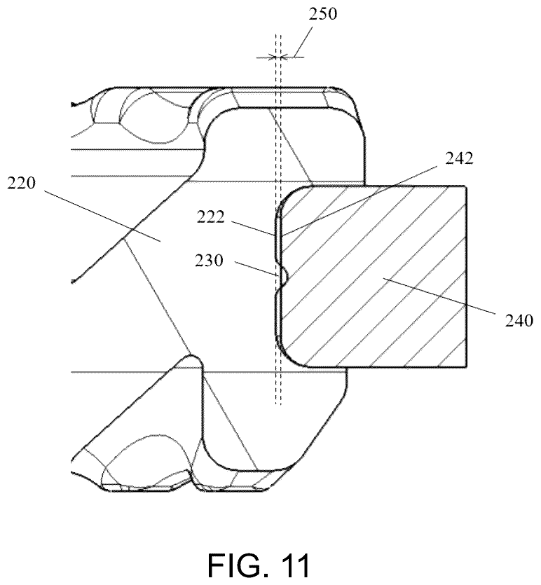

FIG. 11 shows the circular gap 250 between the base 220 and the circular opening of the mount 240 when the support is inserted into the circular opening. The circular gap is induced by the manufacturing tolerances of the various parts of the damping assembly (base, damping cylinder and/or mount). This circular gap 250 lies between the damping cylinder 220 and the circular opening of the mount 240, in other words, between the outer lateral surface 222 of the damping cylinder and the edge 242 of the circular opening. The outer lateral surface 222 of the cylinder has a diameter less than the diameter of the edge 242 of the circular opening. The radial projection 230 protrudes from the outer lateral surface 222 of said damping cylinder 220 toward the outside of the damping cylinder 220. The radial projection 230 thus fills this circular gap 250 in the assembly, which is located between the damping cylinder 220 and the circular opening of the mount 240.

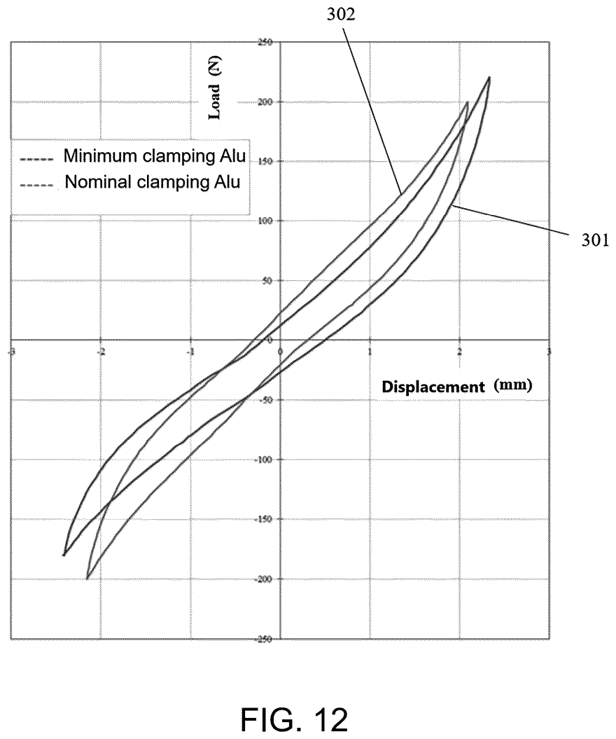

FIG. 12 shows examples of measured radial curves for damping assemblies such as that of FIG. 10. In particular, the figure shows a first radial curve 301 measured for a first example of a damping assembly in which the clamping between the support and the mount is minimal, and a second radial curve 302 measured for a second example of a damping assembly in which the clamping between the support and the mount is maximal. In each of these examples, the clamping between the support and the mount is the result of dimensional variations induced by the manufacturing tolerances of the parts in the assembly, which results in greater or lesser clamping between the support and the mount. The figure shows that in these two examples, the radial projection allows degradation of stiffness at the origin to be avoided. Indeed, for both clamping operations, stiffness remains constant at the origin. The figure shows that the radial projection allows to compensate for dimensional variations in the parts induced by the manufacturing tolerances. Indeed, the two examples, although different in terms of dimension, both provide even and adequate damping, even at the origin. The radial projection of these assemblies therefore does indeed prevent the stiffness degradation otherwise observed in existing damping assemblies.

The tables below also show the results measured statically (left-hand table) and dynamically (right-hand table) for the first example of a damping assembly in which the clamping between support and mount is minimal. The results show that, even with such clamping, stiffness remains within the lower and upper tolerances (“Low Tol.” and “Upp Tol.”) of the desired specification value (“Spec.”).

| | RADIAL |
|---|---|
| | V |
| | Stiffness for +/− 200N (N/mm) |
| DEP | −1/1 mm |
| Spec. | 60 |
| Low. Tol. | 42 |
| Upp. Tol. | 78 |
| 8 | 60 |

RADIAL
V

| | Stiffness for 35 Hz | Tangent for 35 Hz |
|---|---|---|
| | at +/− 0.5 mm (N/mm) | at +/− 0.5 mm (N/mm) |
| Spec. | 110 | |
| Low. Tol. | 77 | |
| Upp. Tol. | 143 | |
| 8 | 108 | 0.25 |

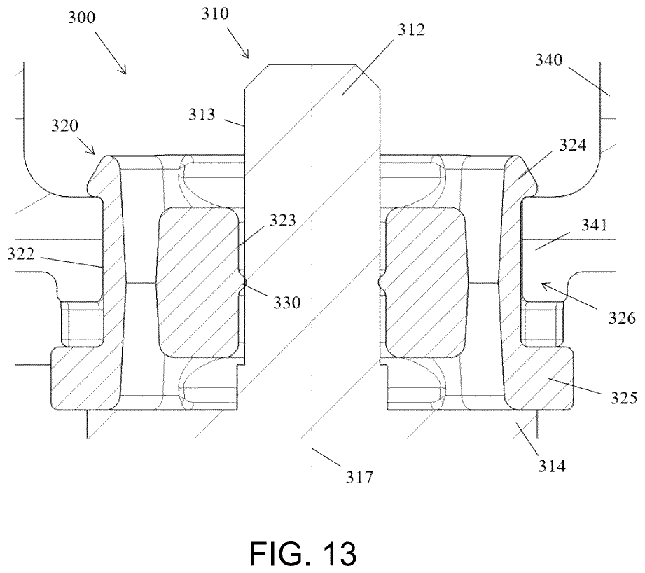

FIG. 13 shows another example of a damping assembly. This other example is according to the second of the options discussed above. In this other example, the radial projection 330 protrudes from the inner lateral surface 323 of the damping cylinder 320. The damping assembly comprises a support 300 and a mount 340 comprising a circular opening into which the support 300 may be inserted.

The support 300 comprises a base 310 presenting a rod 312 having a cylindrical outer lateral surface 313 and a shoulder 314 arranged at one end of the rod 312. The shoulder 314 has the shape of a disk centered and perpendicular to the axis 317 of the support 300, which is also that of the rod 312 and the damping cylinder 320. The shoulder 314 may serve to support a mechanical part, such as a radiator. The support of the mechanical part may result from contact with an upper surface of the shoulder 314, this contact blocking the displacement of the mechanical part in the direction of the support axis 317.

The support 300 also comprises the damping cylinder 320. The damping cylinder 320 comprises an inner lateral surface 323 surrounding the outer lateral surface of the rod 312 and an outer lateral surface 322. The inner lateral surface 323 is cylindrical in shape and has a diameter slightly greater than that of the rod 312, resulting in a circular gap between the inner lateral surface 323 and the outer lateral surface 313 of the rod 312 when the support 300 is inserted into the circular opening of the mount 340. This circular gap is filled by the radial projection 330 protruding from the inner lateral surface 323.

The outer lateral surface 322 is configured to, when the support 300 is inserted into the mount 340, hold the support 300 on the mount 340. In particular, the outer lateral surface 322 is configured to be held on the circular opening of the mount 340. In this example, the two ends of said damping cylinder comprise a respective shoulder 324, 325 forming a circumferential groove 326 around the cylinder. The damping cylinder 320 is held on the circular opening of the mount 340 by inserting the circular edge 341 of the circular opening into this circumferential groove 326 formed by the shoulders 324, 325.

The damping cylinder 320 comprises the radial projection 330, which is unique and protrudes from the inner lateral surface 323 of the damping cylinder 320. The radial projection 330 is, when the support 300 is inserted into the circular opening of the mount 340, compressed in the circular gap between the inner lateral surface 323 of the damping cylinder and the outer lateral surface 313 of the rod 312. The radial projection 330 encircles the circumference of the inner lateral surface 323. The radial projection 330 is positioned longitudinally, in other words, along the support axis 317, substantially at the center of the rod 312 of the base 310 and the damping cylinder 320. The radial projection 330 is positioned longitudinally at the center of the inner lateral surface 323 of the damping cylinder.

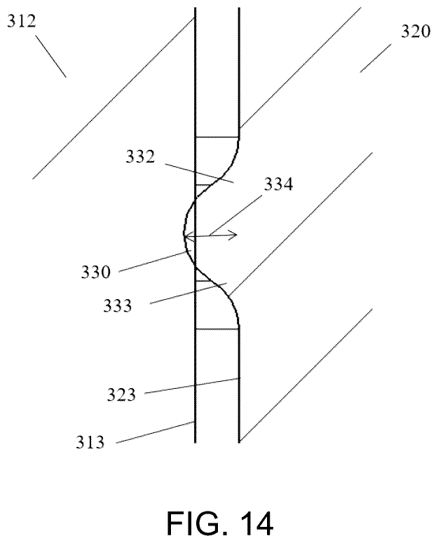

The radial projection 330 is now discussed in more detail with reference to FIG. 14. In this example, the radial projection 330 has a generally semicircular cross-sectional shape. The radial projection 330 also comprises rounded edges 332, 333 at the junctions with the inner lateral surface 323 of the damping cylinder 320. The cross-section of the radial projection 330 is constant around the entire circumference of the inner lateral surface 323. The radial projection 330 has a thickness 334 greater than the result of the sum of the manufacturing tolerance of the base 310 and the manufacturing tolerance of the damping cylinder 320.

1. A damping assembly comprising:
a mount comprising a circular opening, and
a support configured to be inserted into the circular opening of the mount,
the support comprising:
a base having a cylindrical outer lateral surface, and
a damping cylinder comprising an inner lateral surface surrounding the outer lateral surface of the base and an outer lateral surface configured to be held on the circular opening,
wherein the damping cylinder comprises at least one radial projection protruding from the inner lateral surface of the damping cylinder or from the outer lateral surface of the damping cylinder.

2. The damping assembly of claim 1, wherein the damping assembly comprises a circular gap between the base and the circular opening when the support is inserted into the circular opening, the at least one radial projection having a radial thickness greater than that of the circular gap.

3. The damping assembly of claim 1, wherein the thickness of the at least one radial projection is greater than the result of the sum of the manufacturing tolerance of the mount or the base and the manufacturing tolerance of the damping cylinder.

4. The damping assembly of claim 1, wherein the damping cylinder comprises a single radial projection, the single radial projection being positioned longitudinally substantially at the center of the base.

5. The damping assembly of claim 1, wherein the damping cylinder comprises a plurality of radial projections, the radial projections being distributed longitudinally along the base.

6. The damping assembly of claim 1, wherein both ends of the damping cylinder comprise a respective shoulder forming a circumferential groove around the damping cylinder, and the circular opening comprising a circular edge, the damping cylinder being held on the circular opening by insertion of the circular edge of the circular opening into the circumferential groove.

7. The damping assembly of claim 1, wherein the damping cylinder is of elastomeric material.

8. The damping assembly of claim 1, wherein the at least one radial projection extends over all or part of the circumference of the damping cylinder.

9. A support belonging to a damping assembly, the damping assembly comprising:
a mount comprising a circular opening, and
the support configured to be inserted into the circular opening of the mount,
the support comprising:
a base having a cylindrical outer lateral surface, and
a damping cylinder comprising an inner lateral surface surrounding the outer lateral surface of the base and an outer lateral surface configured to be held on the circular opening,
wherein the damping cylinder comprises at least one radial projection protruding from the inner lateral surface of the damping cylinder or from the outer lateral surface of the damping cylinder.

10. The support of claim 9, wherein the damping assembly comprises a circular gap between the base and the circular opening when the support is inserted into the circular opening, the at least one radial projection having a radial thickness greater than that of the circular gap.

11. The support of claim 9, wherein the thickness of the at least one radial projection is greater than the result of the sum of the manufacturing tolerance of the mount or the base and the manufacturing tolerance of the damping cylinder.

12. The support of claim 9, wherein the damping cylinder comprises a single radial projection, the single radial projection being positioned longitudinally substantially at the center of the base.

13. The support of claim 9, wherein the damping cylinder comprises a plurality of radial projections, the radial projections being distributed longitudinally along the base.

14. The support of claim 9, wherein both ends of the damping cylinder comprise a respective shoulder forming a circumferential groove around the damping cylinder, and the circular opening comprising a circular edge, the damping cylinder being held on the circular opening by insertion of the circular edge of the circular opening into the circumferential groove.

15. A method of manufacturing a support belonging to a damping assembly, the damping assembly comprising:
a mount comprising a circular opening, and
the support configured to be inserted into the circular opening of the mount,
the support comprising:
a base having a cylindrical outer lateral surface, and
a damping cylinder comprising an inner lateral surface surrounding the outer lateral surface of the base and an outer lateral surface configured to be held on the circular opening,
wherein the damping cylinder comprises at least one radial projection protruding from the inner lateral surface of the damping cylinder or from the outer lateral surface of the damping cylinder.

16. The method of claim 15, wherein the damping assembly comprises a circular gap between the base and the circular opening when the support is inserted into the circular opening, the at least one radial projection having a radial thickness greater than that of the circular gap.

17. The method of claim 15, wherein the thickness of the at least one radial projection is greater than the result of the sum of the manufacturing tolerance of the mount or the base and the manufacturing tolerance of the damping cylinder.

18. The method of claim 15, wherein the damping cylinder comprises a single radial projection, the single radial projection being positioned longitudinally substantially at the center of the base.

19. The method of claim 15, wherein the damping cylinder comprises a plurality of radial projections, the radial projections being distributed longitudinally along the base.

20. The method of claim 15, wherein both ends of the damping cylinder comprise a respective shoulder forming a circumferential groove around the damping cylinder, and the circular opening comprising a circular edge, the damping cylinder being held on the circular opening by insertion of the circular edge of the circular opening into the circumferential groove.
